(19) United States
(12) Patent Application Publication
(10) Pub. No.: US 2010/0116399 A1
(43) Pub. Date: May 13, 2010

(54) Pneumatic Tire and Rim

(76) Inventor: JOHN S. ADAMS, GROTON, MA (US)

Correspondence Address: LAMBERT & ASSOCIATES, P.L.L.C., 92 STATE STREET, BOSTON, MA, 02109-2004, US

(21) Appl. No.: 12/270,011

(22) Filed: Nov. 13, 2008

(51) Int. Cl. B60C 5/02

(52) U.S. Cl. 152/510

(57) ABSTRACT

To provide a tire tube having excellent sealing performance and long lasting durability. The tire tube contains a primary and secondary cavity, each having multiple ports. In the event of a tire rupture or puncture within the primary cavity, the secondary cavity can be inflated manually through a secondary tire valve, or via a rapid pressurization utilizing an actuation value and a pressurized cavity within the rim structure. An adhesive impregnated rubber or synthetic layer bonded to a tubular layer will form the boundary between the wall separating the primary and secondary cavities, and provide a filler to seal the leak in the primary cavity tube outer wall, and into the tire itself.

### BACKGROUND OF THE INVENTION

1. Field of the Invention

The present invention relates to tires and more particularly to self-sealing tires for bicycle wheels.

2. Description of the Related Prior Art

In the known art, descriptions have been given of self-sealing tires provided with at least one layer comprising a polymeric material which can adhere to the object causing the puncture and can also flow into the puncture site when said object is removed, thus sealing the puncture and preventing the outflow of air from the tire.

Currently, there exist pneumatic tires with puncture sealing materials wherein these tires are often made of an elastomer material, such as rubber, with reinforcing materials such as fabric and wire. Bicycle tires that rupture during use require immediate repair, and can result in time prolonged delays as well as potential endangerment to the user depending on the location of the rupture. The potential for a tire rupture forces the user to carry spare tire tubes, or failing that, to call for assistance. Furthermore, the process of repair can be time-consuming and burdensome, eliminating racers from competition, or holding up groups of riders. Additionally, tire ruptures impact those who rely on bicycles as a primary mode of transportation, particularly with the current emphasis on reducing fuel consumption.

An alternative to preventing tire ruptures would be to use foam-filled or solid rubber tires. However, solid and foam-filled tires are heavy, and provide a rough ride, thereby reducing the air cushion, which is a critical element of shock absorption in traditional bicycle tires. The proposed invention involves the use of a multi-cavity tire tube with multiple ports, whereas prior art in the field has focused on the use of a single cavity tire tube, which is illustrated in FIG. 4.

In the event of a rupture in the primary cavity, the secondary cavity can be inflated, thereby collapsing the primary cavity. Subsequently, a rubber or synthetic layer with an attached adhesive impregnated surface layer will form the boundary separating the primary and secondary cavities. This adhesive impregnated rubber or synthetic layer provides a filler to seal the leak in the primary cavity, and into the tire itself. The secondary cavity may be filled manually through a secondary tire valve, or via a rapid pressurization utilizing an actuation value and a pressurized cavity within the tire rim structure.

### SUMMARY OF THE INVENTION

The instant invention, as illustrated herein, is clearly not anticipated, rendered obvious, or even present in any of the prior art mechanisms, either alone or in any combination thereof. In view of the limitations now present in the prior art, the present invention provides a new and useful Pneumatic Tire and Rim Featuring Manual Fill and Auto-Fill of use thereof, which is more universally functional and more versatile in operation than simply repairing or changing out a tire when a rupture occurs during a ride or using foam-filled or solid rubber tires.

The primary object of the instant invention is to provide for a multi-cavity tire tube having multiple ports. If a rupture occurs in the primary cavity, then the second cavity can be inflated, collapsing the primary cavity. A rubber or synthetic layer with an adhesive impregnated surface will form the boundary between the wall separating the primary and secondary cavities, and provide a filler to seal the leak in the tube outer wall, and into the tire itself. The secondary cavity can be filled manually through a secondary tire valve, or via a rapid pressurization utilizing an actuation value and a pressurized cavity within the tire rim structure.

Another object of the present invention is to provide the rider with an alternative to changing out a tire tube in the event that there is a tire rupture. In the event of a tire rupture, the rider would manually inflate the second cavity via the secondary valve.

As a result, the tubular layer will invert, pressing against the outer wall of the tube. The adhesive layer will be pressed between the tubular layer and the outer wall of the tube. As the pressure increases, the adhesive layer will fill the rupture of the tire tube, and thus, ensure that there is a strong boundary between the secondary air cavity and the ground. The valve for cavity A will collapse into the rim as the tubular layer is pressed into the tire, making it apparent that the tube needs to be changed off-line at a more convenient time following the ride.

In a more advanced aspect of the solution, in the event of a tire rupture, the rider would use a basic tool to actuate a sealed piston in the rim structure. The rim would have a pressurized structural module as part of the design, and act as a backup air source. By actuating the sealed piston, the rider would inflate the second cavity as described above. This would be much more rapid than a manual inflation, and would be useful in a racing environment where every second counts, or for those who do not wish to manually inflate their tires.

In a highly advanced solution, tire pressure sensors, as used on automobiles, would be used to monitor tire pressure, and when low or at zero, would communicate with a biking computer or handheld device such as an iPhone via an API and a communication protocol such as Bluetooth. The rider would have the ability to actuate the sealed piston over the communication protocol leveraging an actuating valve to release the air pressure into the tire.

In an optimal embodiment, the volume of the pressurized module would be close to that of the tire, so that actuating the valve would link the two chambers for a near instantaneous pressurization that would result in a pressure in the mid-range of the rating of the tire. Advanced applications would be able to monitor the tire pressure, and incrementally actuate the sealed piston to enable precise pressurization of the tire, maintaining different pressure levels in the tire and pressurized reservoir module. In one embodiment, there are two separate pressure reservoirs in the rim, one serving cavity A and the other cavity B of the tire to enable precision adjustment in each application.

These together with other objects of the invention, along with various features of novelty which characterize the invention, are pointed out with particularity in the claims, Detailed Description of the Embodiments Sections and drawings of this application, with all said sections adding to this disclosure.

### BRIEF DESCRIPTION OF THE DRAWINGS

The invention will be described by way of example and with reference to the accompanying drawings in which:

FIG. 1 is an isometric view of the instant invention having a rim, a multi-cavity tube, a plurality of radial supports and a pair of air valves.

FIG. 2 is a cross-sectional front view of a prior art single cavity tube tire.

FIGS. 3A and 3B illustrate a cross-sectional exploded view of the multi-cavity tube assembly contained within the instant invention.

FIG. 4 is an exploded view of a prior art tire having a single cavity tube assembly.

FIG. 5A illustrates an exploded view of the multi-cavity tube assembly prior to rupture, wherein the primary cavity is inflated, and the secondary cavity is deflated.

FIG. 5B illustrates an exploded view of the multi-cavity tube assembly after rupture, wherein the primary cavity is deflated, and the secondary cavity is inflated.

FIG. 5C illustrates operation of the secondary air valve in the inflated upright position following the inflation of the secondary cavity.

FIG. 6A illustrates an alternate embodiment of the instant invention having a sealed piston for operation of the multi-cavity tube assembly for inflation, wherein the primary cavity is inflated and the secondary cavity is deflated.

FIG. 6B illustrates the alternate embodiment of the instant invention having a sealed piston for operation of the multi-cavity tube assembly for inflation, wherein the primary cavity is deflated and the secondary cavity is inflated.

### DETAILED DESCRIPTION OF THE PREFERRED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as the use of tire pressures sensors to monitor tire pressure.

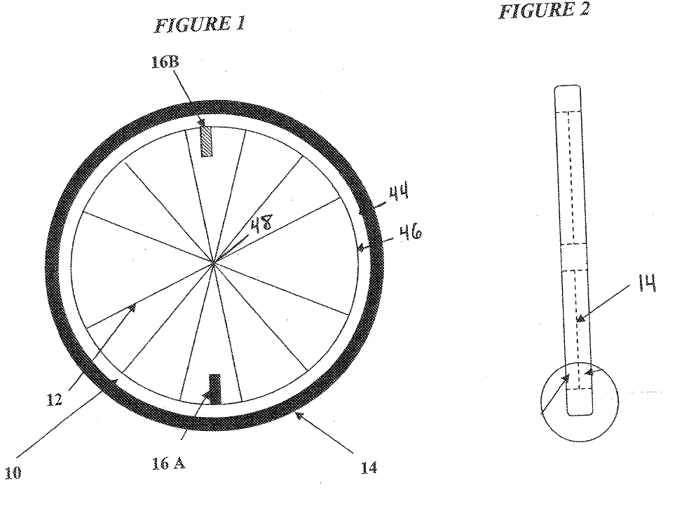

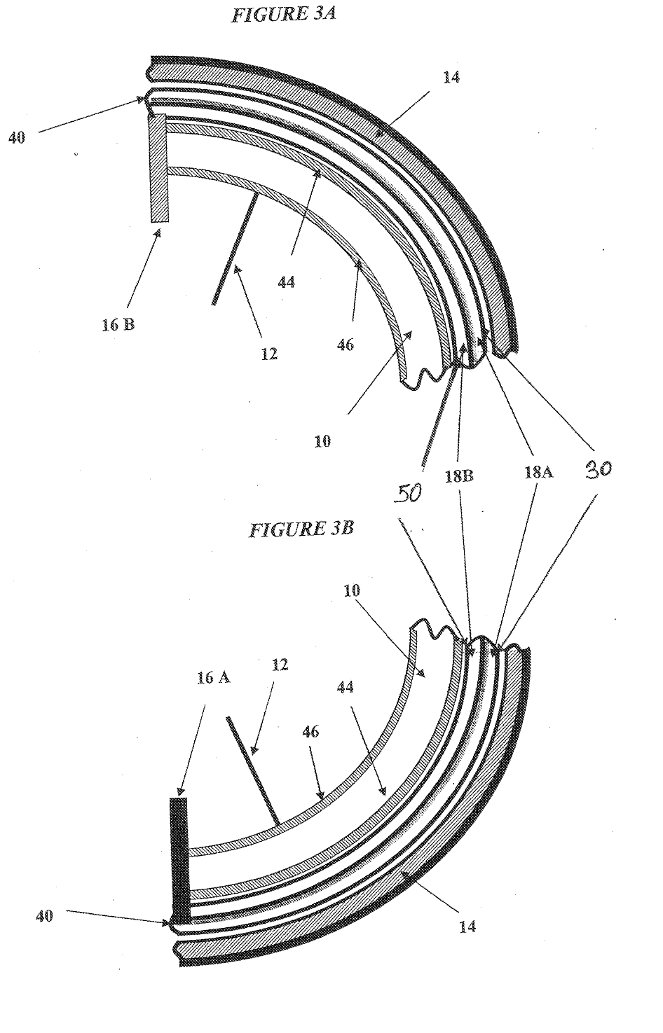

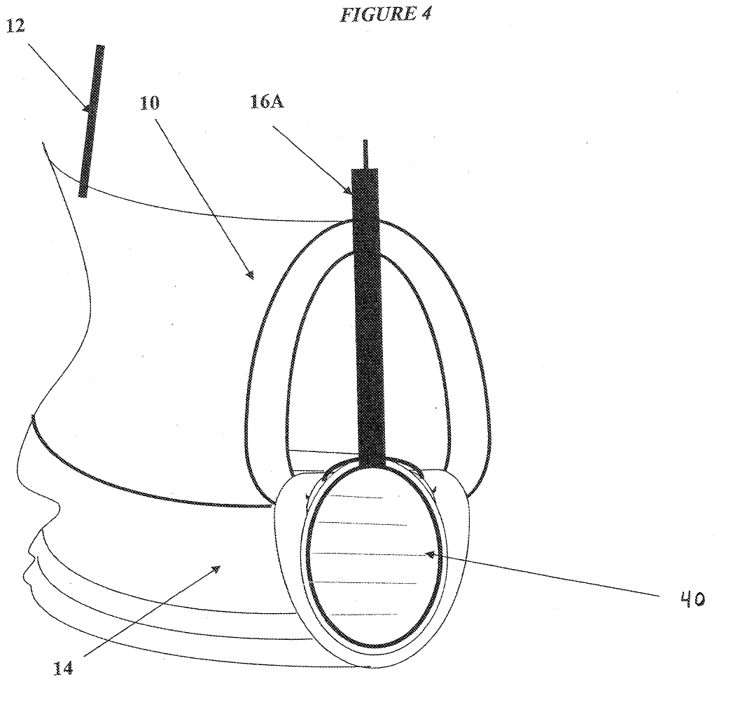

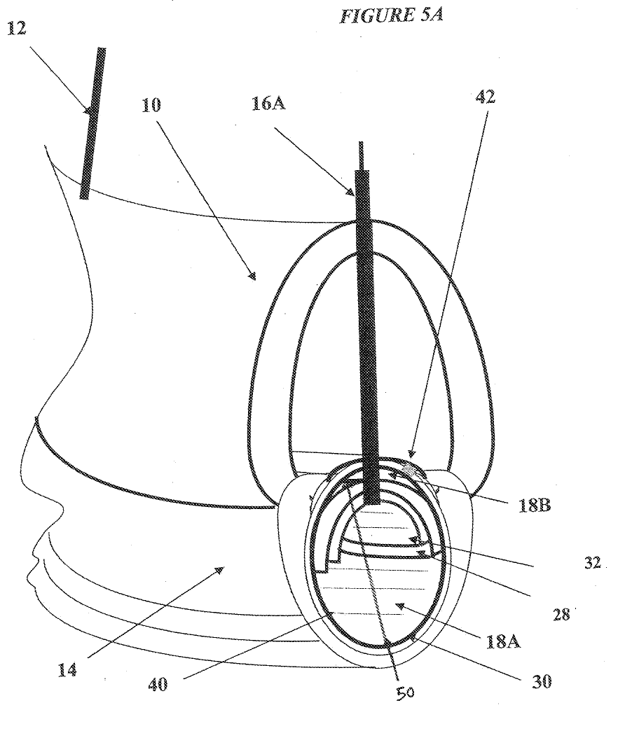

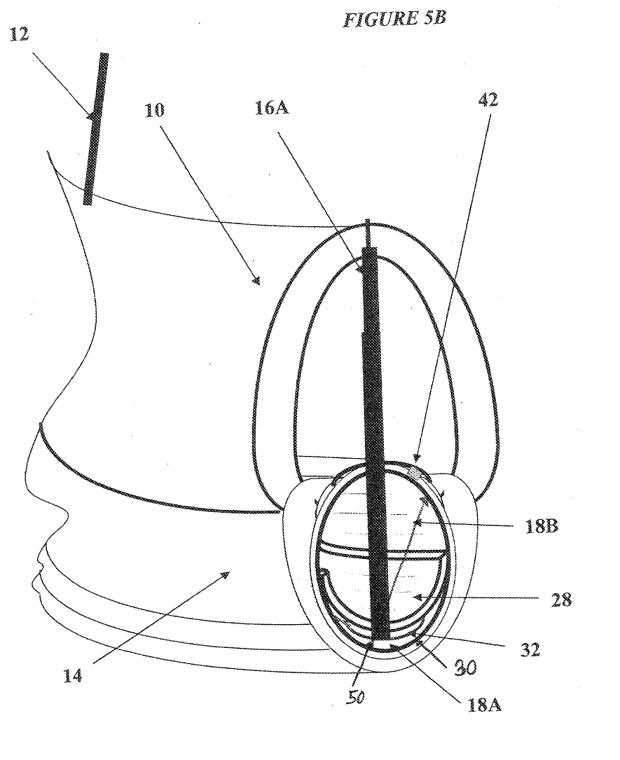

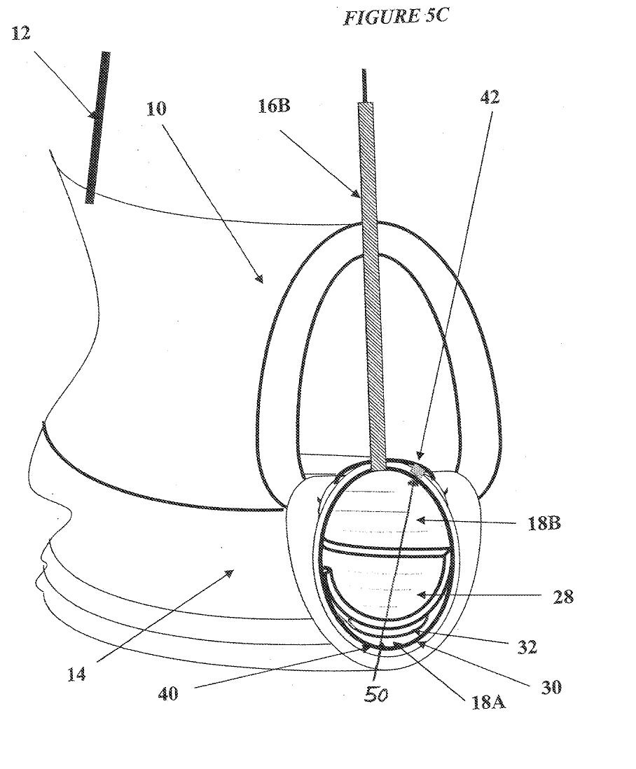

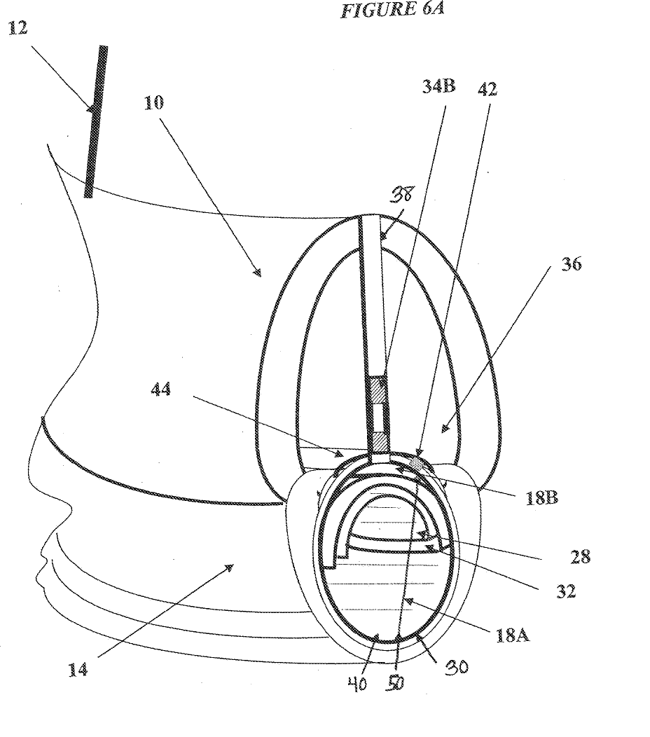

FIG. 1 illustrates an improved pneumatic tire, having a rim 10, wherein the rim 10 includes an inside wall 46 and an outside wall 44. A tire 14 is attached to the outside wall 44, and extends along the circumference of the rim 10. A multi-cavity tube 40 is housed within the tire 14, wherein the multi-cavity tube 40 and includes a primary cavity 18A and secondary cavity 18B (see FIGS. 3A and 3B). A plurality of radial supports 12 is preferably equidistantly disposed along the inside wall 46 of the rim 10 and extend inwardly towards the center 48 of the tire 10. In a preferred embodiment, the radial supports 12 are spokes. A plurality of pressure sensors 42 (see FIG. 5A) is disposed within the inside wall 46 of the rim 10, wherein the pressure sensors 42 are disposed to measure the pressure of the multi-cavity tube 40 against the rim 10. A primary air valve 16A is disposed along the inside wall 46 of the rim 10 and extends downwardly into the primary cavity 18A (see FIG. 5A), wherein the primary air valve 16A charges air into the primary cavity 18A (see FIG. 5A). A secondary air valve 16B is disposed along the inside wall 46 of the rim 10 and extends downwardly into the secondary cavity 18B (see FIG. 5B), wherein the secondary air valve 16B charges air into the secondary cavity 18B (see FIG. 5B). Preferably, the pair of air valves 16A and 16B are located substantially opposite each other on the rim 10.

FIG. 2 illustrates a cross-sectional view of a prior art pneumatic tire with a single cavity tube.

FIGS. 3A and 3B illustrate a cross-sectional, exploded view of the multi-cavity tube assembly 40, wherein the multi-cavity tube 40 further includes an inner wall 50 and an outer wall 30. The outer wall 30 of the multi-cavity tube 40 is situated against the tire 14, and the inner wall 50 of the multi-cavity tube 40 is situated against the outside wall 46 of the rim 10. The inner wall 50 of the tube 40 extends along the circumference of the rim 10 and the tubular layer 28 (see FIG. 5A).

FIG. 4 illustrates an exploded view of a single tube 40 cavity assembly for a prior art pneumatic tire, having only a single cavity tube 40.

FIG. 5A illustrates an exploded view of the multi-cavity tire tube 40, wherein the primary cavity 18A includes the primary valve 16A for primary cavity 18A pressurization. The multi-cavity tube 40 includes an inner wall 50 and an outer wall 30. An adhesive layer 32 forms the boundary separating the primary 18A and secondary 18B cavities. Furthermore, the adhesive layer 32 acts as a sealant to a leak in the primary cavity 18A, and thus into the tire 14 itself.

In one preferred embodiment (shown in FIGS. 5B and 5C), in the event of a tire rupture, the secondary cavity 18B is manually inflated via the secondary air valve 16B. Once the secondary cavity 18B is manually inflated, the tubular layer 28 will invert, thus pressing against the outer wall 30 of the multi-cavity tube 40. This action will in turn cause the adhesive layer 32 to be pressed between the tubular layer 28 and the outer wall 30 of the multi-cavity tube 40. The increase in pressure will cause the adhesive layer 32 to fill any rupture or puncture of the multi-cavity tube 40 as well as the tire 14. The adhesive layer 32 filling such a rupture or puncture will ensure a strong boundary between the secondary cavity 18B and the ground, and thereby allowing for extended riding time. Furthermore, as the tubular layer 28 is pressed into the tube 40, the primary valve 16A for the primary cavity 18A collapses into the rim 10, thus signaling to the rider that the tire 14 needs to be changed off-line at a more convenient time following the ride.

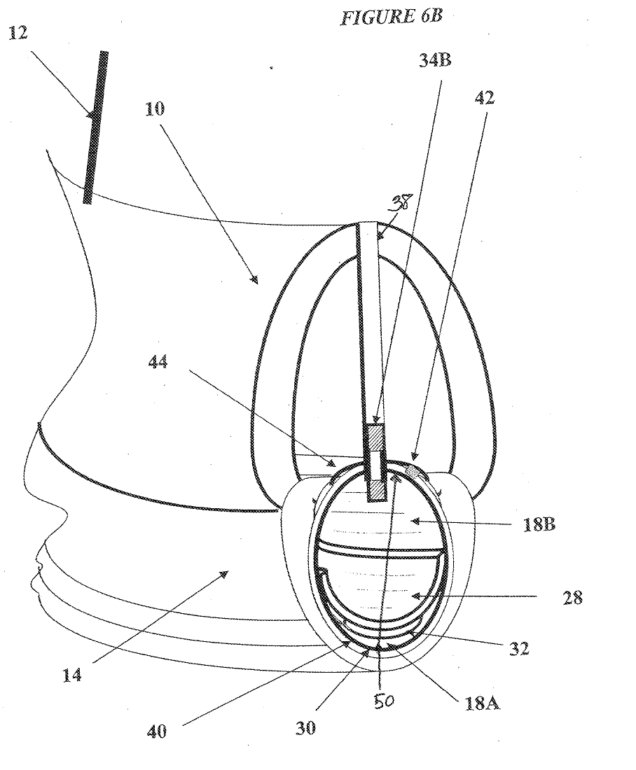

FIGS. 6A and 6B illustrate a second preferred embodiment of the instant invention. A plurality of pressure sensors 42 is disposed within the inside wall 46 of the rim 10, wherein the pressure sensors 42 are disposed to measure the pressure of the multi-cavity tube 40 against the rim 10. In the event of a rupture, a sealed piston 34B located in the rim 10 structure is actuated by the use of a basic tool, such as a screwdriver. A pressurized structural module 36 is located within the rim 10, where in the pressurized structural module 36 stores air that will be released into the secondary cavity 18B upon actuation of the sealed piston 34B. Once the sealed piston 34B is actuated through a piston access channel 38, the secondary cavity 18B is inflated automatically using the same mechanism in manual inflation as described above and reiterated below.

Once the secondary cavity 18B is inflated due to actuating of the sealed piston 34B, the tubular layer 28 will invert, thus pressing against the outer wall 30 of the tube 40. This action will in turn cause the adhesive layer 32 to be pressed between the tubular layer 28 and the outer wall 30 of the tube 40. The increase in pressure will cause the adhesive layer 32 to fill any rupture or puncture of the tube 40 as well as the tire 14. The adhesive layer 32 filling such a rupture or puncture will ensure a strong boundary between the secondary cavity 18B and the ground, and therefore allow for an extended riding time. As the tubular layer 28 in the secondary cavity 18B is pressed into the tube 40, the primary valve 16A for primary cavity 18A collapses into the rim 10, thus signaling to the rider that the tire 14 needs to be changed off-line at a more convenient time following the ride.

Inflation due to actuating the sealed piston would be much more rapid than a manual inflation. Automatic inflation would be useful in a racing environment where every second is of vital importance. Alternatively, automatic inflation would be ideal for those riders who do not wish to manually inflate their tires.

In a highly advanced embodiment, once the tire pressure reaches below a pre-determined threshold, the plurality of pressure sensors 42 would communicate with a biking computer or handheld device such as an iPhone and API and a communication protocol such as a Bluetooth. In this highly advanced solution, the rider would have the ability to actuate the sealed piston 34B over the communication protocol, thereby leveraging an actuating valve to release the air pressure into the tire tube 40.

What is claimed is:

1. A pneumatic tire comprising:
a rim, wherein said rim includes an inside and outside wall;
a multi-cavity tube extending along the circumference of said rim, wherein said multi-cavity tube is attached to the outside wall of said rim;
a primary and secondary cavity, wherein said primary and secondary cavities are housed within said multi-cavity tube;
a plurality of radial supports, disposed along the inside wall of said rim and extending inwardly towards the center of the tire;
a primary air valve disposed along the inside wall of the rim and extending downwardly into the primary cavity; and
a secondary air valve disposed along the inside wall of the rim and extending downwardly into the secondary cavity.

2. The pneumatic tire of claim 1, further comprising a plurality of pressure sensors, wherein said sensors are mounted on the inside wall of said rim.

3. The pneumatic tire of claim 2, wherein the plurality of pressure sensors are disposed to measure the pressure of the multi-cavity tube against said rim.

4. The pneumatic tire of claim 1, further comprising an adhesive layer substantially located between the primary and secondary cavities, wherein the adhesive layer forms the boundary between the cavities.

5. The pneumatic tire of claim 4, further comprising a tubular layer, wherein said tubular layer is disposed above the adhesive layer.

6. The pneumatic tire of claim 1, wherein the means for inflating the multi-cavity tube is manual.

7. The pneumatic tire of claim 4, wherein the adhesive layer is attached to the tubular layer, thereby forming the boundary that separates the primary cavity from the secondary cavity.

8. The pneumatic tire of claim 4, wherein the adhesive layer provides a filler to seal a puncture in an outer wall in the primary cavity.

9. The pneumatic tire of claim 5, wherein upon inflation of the secondary cavity, the tubular layer inverts, thereby pressing against the outer wall of the multi-cavity tube.

10. The pneumatic tire of claim 5, wherein the tubular layer pressing against the outer wall of the tube causes the adhesive layer to be pressed between the tubular layer and the outer wall of the multi-cavity tube.

11. The pneumatic tire of claim 3, wherein an adhesive layer is composed of a material selected from the group consisting of rubber, flexible cellular foam, flexible polyurethane foam, flexible open cell polyurethane pu foam, flexible polymer-modified acrylic adhesive impregnated foam, flexible silicon foam, flexible reticulated foam, fibrous material, flexible glass cloth, flexible pressure-sensitive backed foam, flexible closed cellular foam, and neoprene foam.

12. A pneumatic tire comprising:
a rim, wherein said rim includes an inside and outside wall;
a multi-cavity tube extending along the circumference of said rim, wherein said multi-cavity tube is attached to the outside wall of said rim;
a primary and secondary cavity, wherein said primary and secondary cavities are housed within said multi-cavity tube;
a plurality of pressure sensors mounted on the inside wall of said rim;
a plurality of radial supports, disposed along the inside wall of said rim and extending inwardly towards the center of the tire;
a primary air valve disposed along the inside wall of the rim and extending downwardly into the primary cavity;
a secondary air valve disposed along the inside wall of the rim and extending downwardly into the secondary cavity;
a piston access channel extending downwardly from said rim through said primary and said secondary cavities; and
a sealed piston, wherein said piston is located within said piston access channel.

13. The pneumatic tire of claim 12, wherein the plurality of pressure sensors are disposed to measure the pressure of the multi-cavity tube against said rim.

14. The pneumatic tire of claim 12, further comprising an adhesive layer substantially located between the primary and secondary cavities, wherein the adhesive layer forms the boundary between the cavities.

15. The pneumatic tire of claim 12, further comprising a tubular layer, wherein said tubular layer is disposed above the adhesive layer.

16. The pneumatic tire of claim 12, wherein the means for inflating the multi-cavity tube is by actuating the sealed piston.

17. The pneumatic tire of claim 14, wherein the adhesive layer is attached to the tubular layer, thereby forming the boundary that separates the primary cavity from the secondary cavity.

18. The pneumatic tire of claim 14, wherein the adhesive layer provides a filler to seal a puncture in an outer wall in the primary cavity.

19. The pneumatic tire of claim 15, wherein upon inflation of the secondary cavity, the tubular layer inverts, thereby pressing against the outer wall of the multi-cavity tube.

20. The pneumatic tire of claim 15, wherein the tubular layer pressing against the outer wall of the tube causes the adhesive layer to be pressed between the tubular layer and the outer wall of the multi-cavity tube.

21. The pneumatic tire of claim 15, wherein an adhesive layer is composed of a material selected from the group consisting of rubber, flexible cellular foam, flexible polyurethane foam, flexible open cell polyurethane pu foam, flexible polymer-modified acrylic adhesive impregnated foam, flexible silicon foam, flexible reticulated foam, fibrous material, flexible glass cloth, flexible pressure-sensitive backed foam, flexible closed cellular foam, and neoprene foam.
